(19) United States
(12) Patent Application Publication
(10) Pub. No.: US 2022/0081964 A1
(43) Pub. Date: Mar. 17, 2022

(54) PRESS-IN BOTTOM SEAL FOR OVERHEAD GARAGE DOOR

(71) Applicants: James C. Stoesser, Palatine, IL (US); Fred Cam-Koo, Chicago, IL (US); Mark A. Baumhardt, Mundelein, IL (US)

(72) Inventors: James C. Stoesser, Palatine, IL (US); Fred Cam-Koo, Chicago, IL (US); Mark A. Baumhardt, Mundelein, IL (US)

(21) Appl. No.: 17/447,645

(22) Filed: Sep. 14, 2021

Related U.S. Application Data
(60) Provisional application No. 62/706,847, filed on Sep. 14, 2020.

(51) Int. Cl. E06B 3/88

(52) U.S. Cl. CPC E06B 3/88; E06B 2003/7044

(57) ABSTRACT

A press-in astragal for installation in an overhead garage door retainer includes an elongated, flexible, resilient strip. The strip has a first surface and a second surface. A first protrusion and a second protrusion with a half arrow cross-sectional shape extend longitudinally along opposite edges of the first surface. The second protrusion faces opposite the first protrusion. A garage door seal kit includes the press-in astragal, an astragal retainer that accommodates the astragal; and mounting hardware to mount the astragal retainer to a garage door. The retainer has a first channel extending longitudinally along a first edge and a second channel extending longitudinally along a second edge. The first channel has a flattened C-shape cross-section and the second channel has a flattened C-shape cross-section facing opposite the first channel.

### CROSS-REFERENCE TO RELATED APPLICATION

This application claims the benefit of priority of U.S. provisional application No. 62/706,847, filed Sep. 14, 2020, the contents of which are herein incorporated by reference.

### BACKGROUND OF THE INVENTION

The present invention relates to a bottom seal for an overhead garage door and, more particularly, to a press-in seal.

Many overhead doors use an astragal seal as a gasket to provide weather sealing when the overhead door is in the closed or down position.

Currently, commercially available astragal seals use a “t” or rounded bulb tip. Existing astragals must be fed through a rigid retainer slot and slid along the entire length of the bottom of the door. When the door has been installed, the track along the outside edge of door makes the replacement of the astragal very problematic It is difficult to slide the astragal between the roller track holding the door up and the outside edge of the overhead door. Moreover, you must slide the seal from the starting point at one end and keep feeding the seal until you reach the other end of the door. The astragal pinches and binds up as it is fed into the retainer track. The wider the door, i.e., the longer the astragal, the more difficult the reinstallation.

As can be seen, there is a need for a replacement astragal that is easier to install into existing retainers on installed doors.

### SUMMARY OF THE INVENTION

The present invention provides a seal comprising an astragal with an arrow tipped fastening system that is pressed into place along the outside edge of the retainer. The installer may press (i.e., push) the arrow tip into the retainer track until the tip is locked into place along the entire length of the door. It does not matter where the process is started. No pulling, tugging or lubricants needed. This makes replacing a damaged astragal much easier and allows one-man installation.

In one aspect of the present invention, a press-in astragal is provided for installation in an overhead garage door retainer, comprising an elongated, flexible, resilient strip having a first surface and a second surface, with a first protrusion having a half arrow cross-sectional shape extending longitudinally along a first edge of the first surface and a second protrusion having a half arrow cross-sectional shape extending longitudinally along a second edge of the first surface, wherein said second protrusion faces opposite the first protrusion.

In another aspect of the present invention, a garage door seal kit is provided, comprising a press-in astragal comprising an elongated, flexible, resilient strip having a first surface and a second surface, with a first protrusion having a half arrow cross-sectional shape extending longitudinally along a first edge of the first surface and a second protrusion having a half arrow cross-sectional shape extending longitudinally along a second edge of the first surface, with said second protrusion facing opposite the first protrusion; an astragal retainer configured to accommodate the astragal, said retainer having a first channel extending longitudinally along a first edge thereof and a second channel extending longitudinally along a second edge thereof, wherein the first channel has a flattened C-shape cross-section and the second channel has a flattened C-shape cross-section facing opposite the first channel; and mounting hardware configured to mount the astragal retainer to a garage door.

These and other features, aspects and advantages of the present invention will become better understood with reference to the following drawings, description, and claims.

### BRIEF DESCRIPTION OF THE DRAWINGS

FIG. 1 is a perspective view of a seal according to an embodiment of the present invention;

FIG. 2 is a sectional view thereof, taken along line 2-2 in FIG. 1;

FIG. 3 is an exploded view of a retainer and seal, thereof, shown in a flat position;

FIG. 4 is a sectional view of an installation method step according to an embodiment of the present invention;

FIG. 5 is a detail sectional view thereof;

FIG. 6 is another detail sectional view thereof;

FIG. 7 is a sectional view thereof; and

FIG. 8 is another sectional view thereof.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a press-in astragal having arrow points for installation in the tracks of a retainer. The arrow points or male bullet tips are compressible protrusions extending from a surface of the astragal.

As used herein, the term “astragal” refers to a compressible weather stripping seal that runs along the bottom of a garage door to stop drafts or rain.

The materials of construction are not particularly limited. For example, the retainer may be rigid plastic slotted L-retainers, such as polyvinyl chloride (PVC). Alternatively, the retainer may be made of a metal such as aluminum. Similarly, the astragal may be a flexible resin, such as flexible PVC. The plastic parts may be manufactured by extrusion, for example, and cut to a predetermined length.

The length of the astragal and its associated retainer is not particularly limited and varies depending upon the size of the door. The inventive astragal may be installed in retainers of varying dimensions associated with the thickness of the doors.

In some embodiments, the astragal and retainer may be provided as a kit. Preferably, the kit further includes attachment elements, such as self-drilling mounting screws.

In some embodiments, the astragal may be provided in a roll and may be cut to fit the designated retainer.

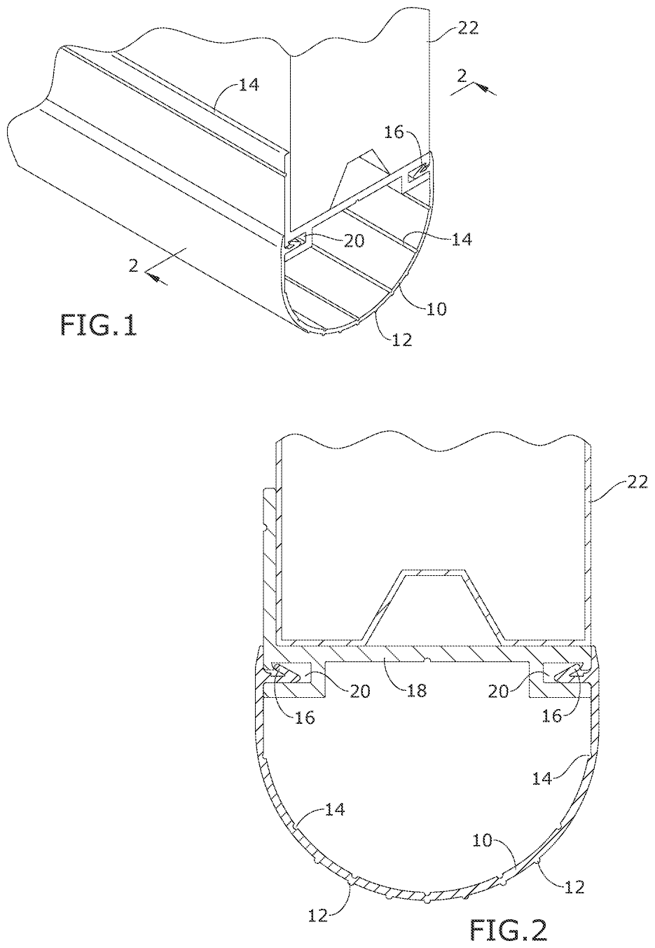

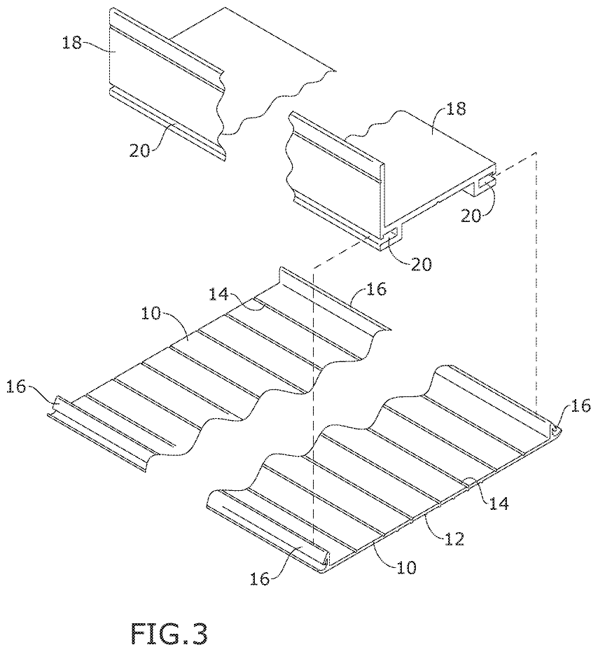

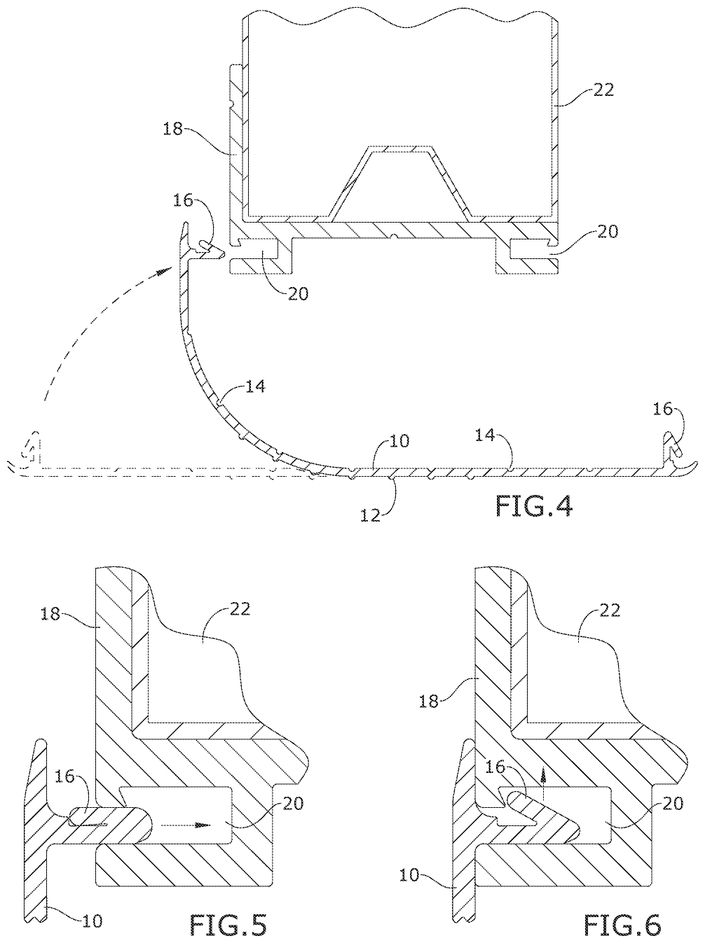

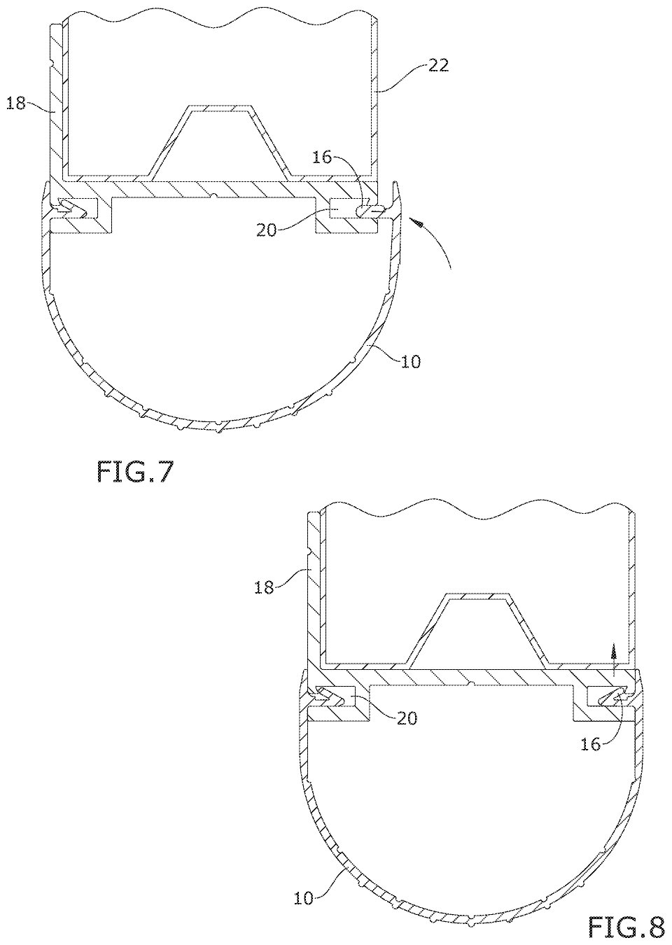

Referring to FIGS. 1 through 8, FIGS. 1-3 illustrate a seal or astragal 10 according to an embodiment of the present invention and a retainer 18 thereof. As can be seen, the astragal 10 has width greater than the width of the overhead garage door retainer 18, forming a compressible arch. FIG. 2 illustrates the astragal 10 in a use position with tips or press-in legs 16 installed into the retainer 18. The astragal 10 may have longitudinal notches 14 to better accommodate the curve formed by the astragal 10 in an in-use position. FIG. 4 illustrates formation of the curve as the astragal 10 is installed. As best shown in FIG. 3, the retainer 18 comprises two opposing retainer tracks or slots 20 on the lower front and rear of the retainer 18 with respect to its position installed on a garage door. As shown in FIGS. 4-8, a method of installing the astragal includes pressing the astragal 10 tips 16 into the retainer slots 20 of the retainer 18 fastened to the bottom panel of the overhead garage door 22. FIGS. 5 and 7 show that as the tips 16 are pressed into the retainer slots 20, the tips 16 compress into a flattened position. As seen in FIGS. 6 and 8, once the tips 16 are fully pressed into the retainer slots 20, they decompress, holding the astragal 10 to the bottom of the overhead garage door 22 and forming the bottom weather seal when the door is in a closed position.

It should be understood, of course, that the foregoing relates to exemplary embodiments of the invention and that modifications may be made without departing from the spirit and scope of the invention as set forth in the following claims.

What is claimed is:

1. A press-in astragal for installation in an overhead garage door retainer, comprising an elongated, flexible, resilient strip having a first surface and a second surface, with a first protrusion having a half arrow cross-sectional shape extending longitudinally along a first edge of the first surface and a second protrusion having a half arrow cross-sectional shape extending longitudinally along a second edge of the first surface, wherein said second protrusion faces opposite the first protrusion.

2. The press-in astragal of claim 1, further comprising longitudinal notches along the first surface.

3. The press-in astragal of claim 1, wherein the press-in astragal has a width greater than the width of the overhead garage door retainer.

4. The press-in astragal of claim 1, configured as a roll.

5. A garage door seal kit comprising:
a. a press-in astragal comprising an elongated, flexible, resilient strip having a first surface and a second surface, with a first compressible protrusion having a half arrow cross-sectional shape extending longitudinally along a first edge of the first surface and a second compressible protrusion having a half arrow cross-sectional shape extending longitudinally along a second edge of the first surface, with said second protrusion facing opposite the first protrusion;
b. an astragal retainer configured to accommodate the astragal, said retainer having a first channel extending longitudinally along a first edge thereof and a second channel extending longitudinally along a second edge thereof, wherein the first channel has a flattened C-shape cross-section and the second channel has a flattened C-shape cross-section facing opposite the first channel; and
c. mounting hardware configured to mount the astragal retainer to a garage door.
